(19) United States
(12) Patent Application Publication
(10) Pub. No.: US 2008/0280188 A1
(43) Pub. Date: Nov. 13, 2008

(54) AIR-BREATHING FUEL CELL STACK

(75) Inventors: YEONG-CHAN EUN, Suwon-si (KR); Jun-won Suh, Suwon-si (KR); Kyoung-hwan Choi, Suwon-si (KR); Sang-kyun Kang, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/039,861

(22) Filed: Feb. 29, 2008

(30) Foreign Application Priority Data
May 7, 2007 (KR) 10-2007-0044207

(51) Int. Cl. H01M 8/04; H01M 2/08

(52) U.S. Cl. 429/35; 429/34

(57) ABSTRACT

An air-breathing fuel cell stack including: a membrane electrode assembly that includes an anode, a cathode, and an electrolyte disposed therebetween; a fuel supplier coupled to the anode, to supply fuel to the anode; a cathode current collector coupled to the cathode; a cathode end plate to support the cathode current collector; and a filter positioned between the cathode current collector and the cathode end plate, to control the moisture content of the membrane electrode assembly.

### CROSS-REFERENCE TO RELATED APPLICATION

This application claims the benefit of Korean Application No. 2007-44207, filed May 7, 2007, in the Korean Intellectual Property Office, the disclosure of which is incorporated herein by reference.

### BACKGROUND OF THE INVENTION

1. Field of the Invention

Aspects of the present invention relate to an air-breathing fuel cell stack that is capable of operating for a long time, while maintaining output.

2. Description of the Related Art

Fuel cells are emission-free power supply apparatuses, and have been highlighted for use in next generation power generation systems. Fuel cells can be used as power generation systems for large buildings, electric vehicles, portable applications, etc. Fuel cells use various fuels, such as, natural gas, city gas, naphtha, methanol, waste gas, etc. Fuel cells can be classified as a molten carbonate fuel cell (MCFC), a solid oxide fuel cell (SOFC), a polymer electrolyte membrane fuel cell (PEFC), a phosphoric acid fuel cell (PAFC), an alkaline fuel cell (AFC), etc., in accordance the type of electrolyte used.

Polymer electrolyte fuel cells can be further classified as a polymer electrolyte membrane fuel cell (PEMFC), or a direct methanol fuel cell (DMFC), in accordance the type of fuel used. The polymer electrolyte membrane fuel cell uses a solid polymer as an electrolyte, therefore, the electrolyte has a lower risk of corrosion or evaporation, and the fuel cell can obtain a high current density per unit area. Polymer electrolyte membrane fuel cells have very high output characteristics and low operating temperatures, as compared to other kinds of fuel cells, and have been actively developed for use as portable power supplies for vehicles, distributed power supplies for buildings, and small power supplies for electronic equipment. Since the direct methanol fuel cells directly use a liquid-phase fuel, such as, methanol, without using a fuel reformer, and are operated at less than 100° C., direct methanol fuel cells are well suited for use as a portable power supplies.

Polymer electrolyte fuel cells include: a membrane electrode assembly (MEA) that includes an anode electrode, at a cathode electrode, and a polymer electrolyte membrane positioned between the anode electrode and the cathode electrode; a separator, and a current collector. The separator includes channels to supply fuel and oxidant. The current collector collects electrons from the anode electrode and supplies electrons to the cathode electrode.

A fuel cell can be classified as an active-type and a passive-type, according to whether a device is used to actively supply air to the cathode electrode. An active-type polymer electrolyte fuel cell uses a fuel pump to supply the fuel to the anode electrode, and uses a pump to supply the oxidant to the cathode electrode. In the case of the passive-type polymer electrolyte fuel cell, the cathode electrode side is open to ambient air, thereby limiting the use thereof where air pollution is heavy. In addition the membrane and/or cathode can be dried, due to the heat generated during high output operations, thereby reducing the performance of the stack. For example, while the polymer electrolyte membrane requires water molecules for the exchange of ions, if the cathode electrode becomes dry, the cathode side of the electrolyte membrane is dehydrated, such that the performance of the stack is considerably reduced.

### SUMMARY OF THE INVENTION

Aspects of the present invention provide an air-breathing fuel cell stack that stably maintains output performance, by supplying clean air to cathode, and by controlling the release of moisture from the stack.

Aspects of the present invention relate to an air-breathing fuel cell stack including: a membrane electrode assembly including an anode, a cathode, and an electrolyte positioned disposed between the anode and the cathode; a fuel supplier coupled to the anode, to supply the fuel to the anode; a cathode current collector contacting the cathode; a cathode end plate to support the cathode current collector; and a filter positioned between the cathode current collector and the cathode end plate.

According to aspects of the present invention, the air flow rate of the filter is 10 l/min·cm², or more, and the moisture flow rate of the filter is 150 Ml/min·cm², or less.

According to aspects of the present invention, the filter includes a plurality of pores, ranging in size between 5 μm to 20 μm.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the exemplary embodiments, taken in conjunction with the accompanying drawings, of which:

FIG. 1 is a perspective view of an air-breathing fuel cell stack, according to an exemplary embodiment of the present invention;

FIG. 2 is a cross-sectional view of the air-breathing fuel cell stack of FIG. 1;

FIG. 3 is an exploded perspective view of the air-breathing fuel cell stack of FIG. 1;

FIG. 4 is a cross-sectional view of an air-breathing fuel cell stack, according to another exemplary embodiment of the present invention;

FIG. 5 is an exploded perspective view of the air-breathing fuel cell stack of FIG. 4; and

FIG. 6 is a graph illustrating a voltage distribution per cell of an air-breathing fuel cell stack, according to changes in the air flow rate and the moisture flow rate of a filter, according to an exemplary embodiment of the present invention.

### DETAILED DESCRIPTION OF THE EMBODIMENTS

Reference will now be made in detail to the exemplary embodiments of the present invention, examples of which are illustrated in the accompanying drawings, wherein like reference numerals refer to the like elements throughout. The exemplary embodiments are described below, in order to explain the aspects of the present invention, by referring to the figures. As referred to herein, when a first element is said to be “disposed” on, or disposed adjacent to a second element, the first element can directly contact the second element, or can be separated from the second element by empty space, or one or more other elements.

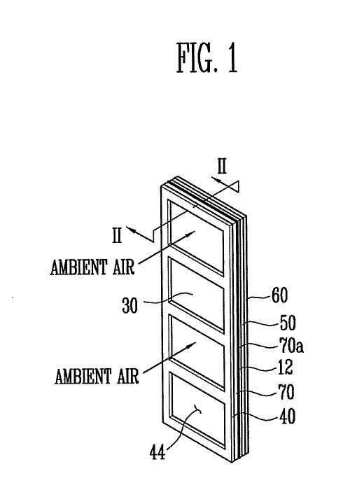

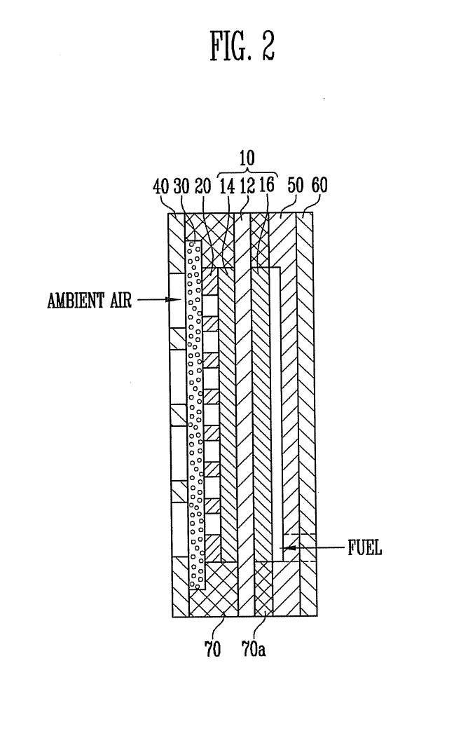

FIG. 1 is a perspective view of an air-breathing fuel cell stack, according to an exemplary embodiment of the present invention, and FIG. 2 is a cross-sectional view of the air-breathing fuel cell stack of FIG. 1. Referring to FIGS. 1 and 2, the air-breathing fuel cell stack includes a membrane electrode assembly (MEA) 10, a cathode current collector 20, a filter 30, a cathode end plate 40, an anode separator 50, an anode end plate 60, a cathode gasket 70, and an anode gasket 70a.

The filter 30 is disposed in the fuel cell stack, adjacent to the cathode 14. The filter 30 prevents the cathode 14 and the electrolyte 12 from drying out. In other words, the filter 30 controls the moisture content of the MEA 10. The filter 30 prevents pollution in ambient air from reaching the cathode 14. The filter 30 is configured to insure sufficient air flow to the cathode 14, and sufficient moisture levels of the MEA 10.

The filter 30 has characteristics that allow for a sufficient flow of the ambient air to the MEA 10, and that limit the discharge of moisture from the MEA 10, to prevent the drying of the cathode and/or membrane, when the air-breathing fuel cell stack is operated. The filter 30 can be made of a cloth, or a resin, coated with a hydrophobic polymer. For example, a micro filter, such as, a TEFLON filter, etc., can be used as the filter 30. The characteristics of the filter 30 can relate to air flow rate, moisture flow rate, and/or pore size of the filter 30.

The filter 30 generally has an air flow rate of 10 l/min·cm², or more, and a moisture flow rate of 150 Ml/min·cm², or less. If the air flow rate of the filter 30 is less than 10 l/min·cm², the output of the stack can be reduced. If the moisture flow rate of the filter 30 exceeds 150 Ml/min·cm², proper humidity control in the MEA 10 can be compromised.

The air flow rate and moisture flow rate of the filter 30 can be measured by operating the stack while using the filter 30, then removing the filter 30 from the stack. The filter 30 is then dried the filter 30 for about one hour, at 50° C. or more, in order to remove a remaining moisture. An air flow rate measuring method is applied to the filter 30, and a moisture flow rate measuring method, using MITEX series products available from MILLIPORE, Inc., is then applied to the dried filter 30.

The filter 30 includes a plurality of pores, ranging in size from about 5 μm to 20 μm, when the filter 30 is completely dried. If the pores of the filter 30 are less than about 5 μm, moisture discharge can be excessively inhibited, thereby causing an excessive amount of moisture to accumulate on the cathode 14. The accumulated moisture can interrupt the supply of air to the cathode 14, i.e., flooding through-holes of the cathode current collector 20 and/or flooding the cathode 14. If the pores of the filter 30 exceed about 20 μm, an excessive amount of moisture is discharged from the cathode 14, through the filter 30, i.e., only a small amount of moisture is condensed in the filter 30. This can result in the drying of the cathode 14.

The filter 30 is designed to have optimal characteristics that insure a proper air flow rate, and a proper moisture flow rate, in order to maintain the humidity of the cathode 14 within a desired range.

The filter 30 can be surface-processed, in order to suppress the influx of pollutants to the cathode, from the ambient air. For example, the filter 30 can have a basic surface that is surface-processed with a basic solution that removes (neutralizes) acidic pollutants. The filter 30 can have an acidic surface that is surface-processed with an acid solution that removes (neutralizes) basic pollutants. Herein, the acidic pollutants include, for example, sulfur oxide, nitrogen oxide, hydrogen sulfide, hydrogen chloride, volatile organic acids, non-volatile organic acids, or the like, and combinations thereof. The basic pollutants include, for example, ammonia, amine, amide, sodium hydroxide, lithium hydroxide, potassium hydroxide, volatile organic bases, non-volatile organic bases, or the like, and combinations thereof.

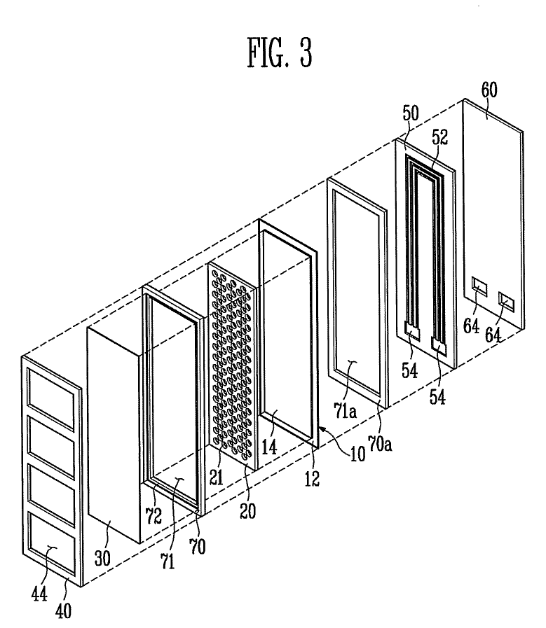

FIG. 3 is an exploded perspective view of the air-breathing fuel cell stack of FIG. 1. Referring to FIGS. 2 and 3, the MEA 10 includes an electrolyte 12, a cathode 14, and an anode 16. The cathode 14 is referred to herein as a cathode electrode, and the anode 16 is referred to as an anode electrode. The MEA 10 generates electricity by chemically reacting fuel supplied to the anode 16, and oxygen supplied to the cathode 16. A hydrocarbon-based fuel, such as, methanol, ethanol, butane gas, etc., or pure/enriched hydrogen gas, can be used as the fuel. In the case of using the methanol as the fuel, the electrochemical reaction of the fuel cell stack can be shown in the following reaction equation 1, and in the case of using the pure hydrogen, or hydrogen-rich reformed gas, as the fuel, the electrochemical reaction of the fuel cell stack can be shown as in the following reaction equation 2.

anode: CH₃OH+H₂O→CO₂+6H⁺+6e⁻

cathode: 3/2O₂+6H⁺+6e⁻→3H₂O

total: CH₃OH+3/2O₂→CO₂+2H₂O [Reaction Equation 1]

anode: H₂(g)→2H⁺+2e⁻

cathode: 1/2O₂+2H⁺+2e⁻→H₂O

total: H₂+1/2O₂→H₂O [Reaction Equation 2]

The electrolyte 12 can be a proton conductive polymer having a thickness of about 50 to 200 μm. The proton conductive polymer may be, for example, a fluorine polymer, a ketonic polymer, a benzimidazolic polymer, an esteric polymer, an amide-based polymer, an imide-based polymer, a sulfonic polymer, a styrenic polymer, a hydro-carbonaceous polymer, etc. For example, of the proton conductive polymer can include poly(perfluorosulfonic acid), poly(perfluorocarboxylic acid), a copolymer of fluorovinylether and tetrafluoroethylene including a sulfonic acid group, defluorinated sulfide polyetherketon, aryl, keton, poly(2,2′-(m-phenylene)-5,5′-bibenzimidazole), (poly(2,2′-(m-phenylene)-5,5′-bibenzimidazole)), poly(2,5-benzimidazole), polyimide, polysulfon, polystyrene, polyphenylene, etc., but is not limited thereto. The electrolyte 12 generally has the thickness of 0.1 mm, or less, to facilitate the transmission of protons.

A solvent can be used to manufacture the electrolyte 12. The solvent can be: an alcohol, such as, ethanol, isopropylalcohol, n-propylalcohol, and butylalcohol; water; dimethylsulfoxide (DMSO); dimethylacetamide (DMAc); N-methylpyrrolidone (NMP); or a combination thereof.

Although not shown in the drawings, the cathode 14 can include a catalyst layer and a backing layer, and the anode can a catalyst layer and a backing layer. The backing layer is referred to as a gas diffusion layer.

The catalyst layers of the cathode 14 and the anode 16 contact both sides of the electrolyte 12, and promote the oxidization of the fuel, and the reduction of oxygen from the ambient air. The catalyst layers of the cathode 14 and the anode 16 can include, for example, a metal catalyst of platinum, ruthenium, osmium, an alloy of platinum-ruthenium, an alloy of platinum-osmium, an alloy of platinum-palladium, and an alloy of platinum-M (M is at least one transition metal selected from a group consisting of Ga, Ti, V, Cr, Mn, Fe, Co, Ni, Cu, and Zn), or a combination thereof. The metal catalyst can be impregnated in a carrier. Any suitable material having conductivity may be used as the carrier, for example, carbon.

The backing layers of the cathode 14 and the anode 16 support the catalyst layers of the cathode 14 and the anode 16, disperse the reactants, i.e., the fuel, water, air, etc., collect and/or distribute electrons, and protect the catalyst materials. The backing layer can be a carbon material, such as, a carbon cloth, or a carbon paper.

The cathode current collector 20 contacts the cathode 14 of the MEA 10, and includes through-holes 21. The ambient air passes through openings 44 of the cathode end plate 40, and then through the through-holes 21. The through-holes 21 can be circular, ovoid, or polygonal. The cathode current collector 20 can include graphite, carbon, a metal surface-coated with a corrosion resistant material, or an alloy with a strong corrosion resistance. For example, the cathode current collector 20 can be stainless steel that is surface-coated with conductive metal particles, to improve conductivity.

The filter 30 is disposed on or adjacent to the cathode current collector 20. The filter 30 is supported by the cathode gasket 70. The filter 30 is generally electrically isolated from the cathode current collector 20.

The cathode end plate 40 contacts the filter 30. The cathode end plate 40 includes the openings 44, through which the ambient air flows.

The anode separator 50 includes a channel 52 through which the fuel flows, and openings 54 connected to both ends of the channel 52. The anode separator 50 can be a mono-polar plate, which has the channel 52 defined in a surface thereof. The anode separator 50 can be formed of the same materials as the cathode current collector 20. For example, the graphite, the carbon, the surface-coated metal, or the alloy. If stainless steel as the material of the anode separator 50, the stainless steel can have conductive metal particles on the surface thereof, which extend through a passive coating, to improve conductivity.

The anode end plate 60 includes two openings 64, through which the fuel is supplied, and which correspond to the openings 54 of the anode separator 50. The anode end plate 60 can be formed: of a metal, such as, aluminum, or an alloy of stainless steel; a polymer composite material, such as, plastic, etc.; a ceramic composite material; and/or a fiber reinforced polymer composite material. The anode end plate 60 is not electrically connected to the anode separator 50. The anode end plate 60 can be formed of a non-conductive material, or can be coated with a non-conductive material.

Although not shown in the drawings, an electrical insulator can be installed between the anode separator 50 and the anode end plate 60. The insulator can be a separate component, or can be an insulation layer coated on the contact surfaces of the anode separator 50 and/or the anode end plate 60.

The cathode gasket 70 is positioned between the MEA 10 and the cathode end plate 40. The cathode gasket 70 has an opening 71 defined in a central portion thereof. The cathode gasket 70 provides a seal between the cathode 14 and the filter 30. The cathode gasket 70 supports the filter 30. The cathode gasket 70 has a step part 72, in which the filter 30 is seated.

The anode gasket 70a is positioned between the MEA 10 and the anode separator 50. The anode gasket 70a has an opening 71a defined in a central portion thereof. The anode gasket 70a provides a seal between the anode 16 and the separator 50. The cathode gasket 70 and the anode gasket 70a are generally formed of an elastic material that is heat resistant. The cathode gasket 70 and the anode gasket 70a can be formed by installing a semi-hardened gasket pad, by applying slurry material that is then cured, or by the combination thereof. The gasket 60 can comprise a rubber or a polymer, for example, ethylene propylene rubber (EPDM), silicon, silicon-based rubber, acrylic rubber, thermoplastic elastomer (TPE), and the like.

Although not shown in the drawings, the air-breathing fuel cell stack includes one or more fasteners to connect the cathode end plate 40 and the anode end plate 60. The fasteners can be, for example, bolts, rivets, pins, or the like, which can be disposed around the periphery of the fuel cell stack.

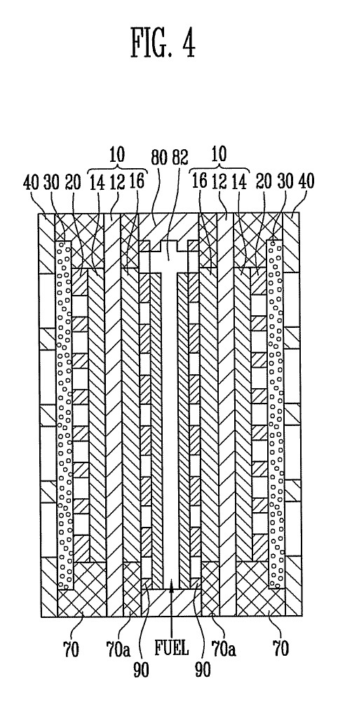

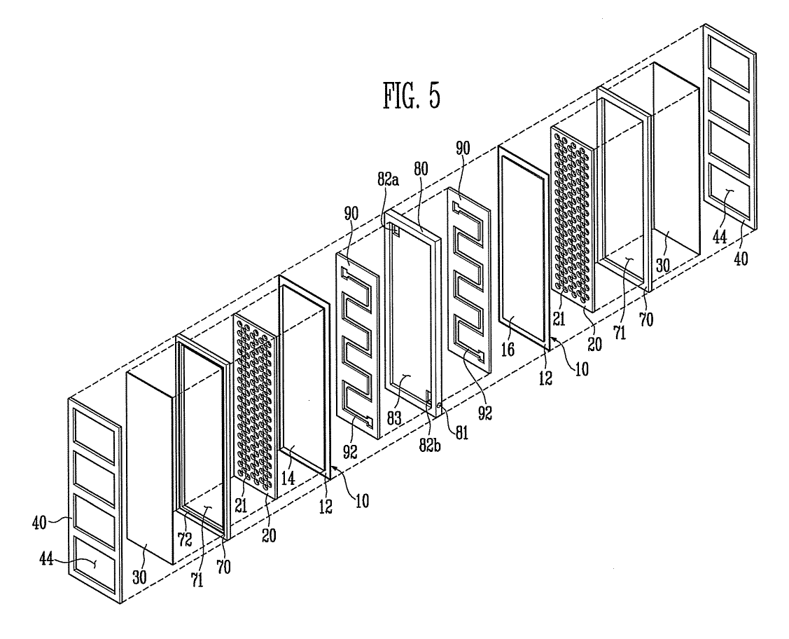

FIG. 4 is a cross-sectional view of an air-breathing fuel cell stack, according to an exemplary embodiment of the present invention. FIG. 5 is an exploded perspective view of the air-breathing fuel cell stack of the FIG. 4.

Referring to the FIGS. 4 and 5, the air-breathing fuel cell stack includes anode current collectors 90, MEAs 10, cathode current collectors 20, cathode gaskets 70, filters 30, and cathode end plates 40, and a middle plate 80 (fuel supplier). One of each of these components are sequentially stacked on opposing sides of the middle plate.

The middle plate 80 includes a first manifold 82 to supply fuel to anodes 16 of the MEAs 10, and a second manifold (not shown) to circulate the fuel. One end of the first manifold 82 is connected to a fuel inlet 81, through which fuel is input, and another end thereof is connected to an opening 82a, through which the fuel flows into channels 92 of the anode current collectors 90. One end of the second manifold is connected to another opening 82b of the middle plate 80, positioned at an opposing end of the channels 92. The fuel in the second manifold is externally discharged through an outlet (not shown), and is then recirculated by a recycler (not shown), so that the fuel can be reused. The middle plate 80 includes seats 83 to seat the anode current collectors 90. The middle plate 80 can be formed of a polymer material, such as, plastic, or the like.

The anode current collectors 90 are conductive metal plates having the channels 92 formed therein. The channels 92 meander along active regions of the anodes 16, so that the fuel supplied through the middle plate 80 is efficiently transferred to the anodes 16. The anode current collectors 90 can be formed of graphite, carbon, a metal surface-coated with a corrosion resistant material, or a corrosion resistant alloy.

Since other components of the air-breathing fuel cell stack are substantially same as components described with reference to FIG. 3, a detailed description thereof is omitted.

The air-breathing fuel cell stack of FIGS. 4 and 5 includes a terminal (not shown) to connect the cathode current collectors 20 with an external circuit (not shown). The air-breathing fuel cell stack includes a terminal (not shown) to connect an anode separator (not shown), or the anode current collectors 90, and the external circuit. The configurations of such terminals are obvious to those skilled in the art, and thus, detailed descriptions and illustrations in the drawings thereof, have been omitted.

Although it has been described that the cathode 14 and the anode 16 include the catalyst layer and the backing layer, the present invention is not so limited. The cathode 14 and the anode 16 can each include the catalyst layer, the backing layer, and a microporous layer positioned therebetween and coated on the one surface of the backing layer. In this case, the microporous layer uniformly distributes fuel or oxidant to each catalyst layer. In particular, the microporous layer adjacent to the cathode 17 exhausts water generated at the catalyst layer of the cathode 17. The microporous layer can include carbon layers coated on the backing layer. The microporous layer may include at least one carbon material selected from a group consisting of graphite, carbon nanotubes (CNT), fullerenes (C60), activated carbon, vulcan, ketjen black, carbon black, and carbon nanohorns. The microporous layer can include at least one binder selected from a group consisting of poly(perfluorosulfonic acid), poly(tetrafluoroethylene), and fluorinated ethylene-propylene.

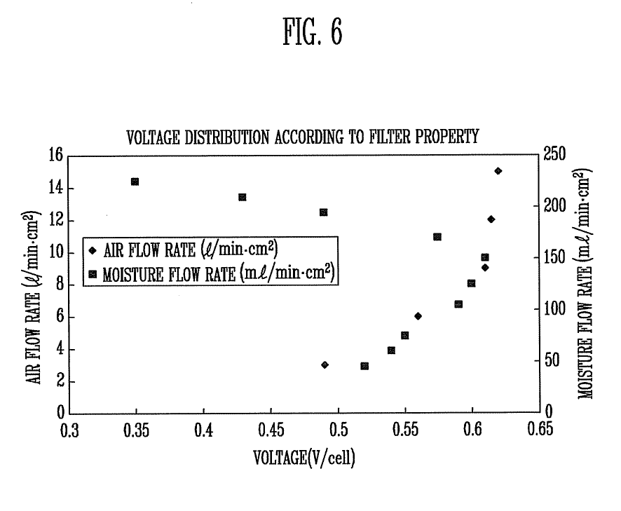

FIG. 6 is a graph illustrating voltage distributions per cell, of the air-breathing fuel cell stack, according to air flow rates and moisture flow rates of the filter 30. During testing, a constant load was connected to the stack.

As seen in the graph of the FIG. 6, in the passive fuel cell system having the air-breathing fuel cell stack mounted therein, when the air flow rates were about 3 l/min·cm², about 6 l/min·cm², and about 10 l/min·cm², cell voltages of about, 0.49V, about 0.56V, and about 0.62V were obtained, respectively. When the air flow rate was about 10 l/min·cm², or more, the cell voltage was maintained at about 0.62V. The voltage did not increase when the air flow rate exceeded 10 l/min·cm², because of an oxygen supply limitations in the passive fuel cell system, for example, a diffusion limitation phenomenon of the cathode side.

In the passive fuel cell system, when the moisture flow rates were about 45 Ml/min·cm², about 55 Ml/min·cm², and about 65 Ml/min·cm², the cell voltages were about 0.52V, about 0.54V, and about 0.55V, respectively. When the moisture flow rates were about 100 Ml/min·cm², about 125 Ml/min·cm², and about 150 Ml/min·cm², the cell voltages were about 0.59V, about 0.60, and about 0.62V, respectively. When the moisture flow rates were about 170 Ml/min·cm², about 200 Ml/min·cm², about 210 Ml/min·cm², and about 220 Ml/min·cm², the cell voltages were about 0.57V, about 0.49V, about 0.43V, and about 0.36V, respectively. The voltage dropped under about 0.55V, when the moisture flow rate was less than about 100 Ml/min·cm², because water generated in the cathode side condensed in the filter, and/or blocked the pores of the diffusion layer of the MEA, thereby blocking the flow of air. The voltage dropped when the moisture flow rate was 170 Ml/min·cm², or more, because the water generated in the cathode side was released, drying the membrane of the MEA, and thereby reducing the ionic conductivity of the electrolyte in the membrane.

The filter, according to aspects of the present invention is generally configured to permit an air flow of 10 Ml/min·cm², or more. The filter is generally configured to permit a moisture flow rate of between about 100 Ml/min·cm² and about 150 Ml/min·cm², but is not limited thereto.

The filter is capable of controlling the inflow of the ambient air and the moisture release of the MEA, within a constant range, thereby improving the output and operating time of the air-breathing fuel cell stack. The filter prevents the drying of the cathode and/or membrane, and suppresses the vaporization of moisture from the cathode side.

According to aspects of the present invention, the anode end plate and the middle plate store fuel, in addition to the roles commonly attributed to such parts. A separate fuel tank is not required, so a fuel cell system can be more compact.

Although a few exemplary embodiments of the present invention have been shown and described, it would be appreciated by those skilled in the art that changes might be made in these exemplary embodiments, without departing from the principles and spirit of the invention, the scope of which is defined in the claims and their equivalents.

What is claimed is:

1. An air-breathing fuel cell stack, comprising:
a membrane electrode assembly comprising an anode, a cathode, and an electrolyte disposed between the anode and the cathode;
a fuel supplier coupled to the anode, to supply a fuel to the anode;
a cathode current collector disposed on the cathode;
a cathode end plate to support the cathode current collector; and
a filter positioned disposed between the cathode current collector and the cathode end plate, to control the moisture content of the membrane electrode assembly.

2. The air-breathing fuel cell stack as claimed in claim 1, wherein the air flow rate of the filter is at least about 10 l/min·cm².

3. The air-breathing fuel cell stack as claimed in claim 2, wherein the moisture flow rate of the filter ranges from about 100 Ml/min·cm² to about 150 Ml/min·cm².

4. The air-breathing fuel cell stack as claimed in claim 1, wherein the air flow rate of the filter is about 10 l/min·cm², and the moisture flow rate of the filter is about 150 Ml/min·cm².

5. The air-breathing fuel cell stack as claimed in claim 1, wherein the filter comprises pores that range in size from about 5 μm to about 20 μm.

6. The air-breathing fuel cell stack as claimed in claim 1, wherein the filter is a micro filter comprising a hydrophobic polymer.

7. The air-breathing fuel cell stack as claimed in claim 6, wherein the filter includes a basic surface to neutralize an acidic pollutant selected from a group consisting of sulfur oxide, nitrogen oxide, hydrogen sulfide, hydrogen chloride, a volatile organic acid, a non-volatile organic acid, and a combination thereof.

8. The air-breathing fuel cell stack as claimed in claim 6, wherein the filter includes an acidic surface to neutralize a basic pollutant selected from a group consisting of ammonia, amine, amide, sodium hydroxide, lithium hydroxide, potassium hydroxide, a volatile organic base, a non-volatile organic base, and a combination thereof.

9. The air-breathing fuel cell stack as claimed in claim 1, wherein:
the fuel supplier comprises a separator disposed upon the anode, having a channel to supply the fuel to the anode; and
the air-breathing fuel cell stack further comprises an anode end plate disposed upon the separator.

10. The air-breathing fuel cell stack as claimed in claim 9, further comprising a fastener to press together the cathode end plate and the anode end plate.

11. The air-breathing fuel cell stack as claimed in claim 10, further comprising a gasket disposed between the membrane electrode assembly and the cathode end plate, to support the filter.

12. The air-breathing fuel cell stack as claimed in claim 11, further comprising a second gasket disposed between the membrane electrode assembly and the anode end plate.

13. An air-breathing fuel cell stack, comprising:
first and second membrane electrode assemblies each comprising an anode, a cathode, and an electrolyte disposed between the anode and the cathode;
a middle plate disposed adjacent to inner surfaces of the first and second membrane electrode assemblies, to supply a fuel to the anodes; and
filters disposed adjacent to outer surfaces of the first and second membrane electrode assemblies, to control the moisture content of the first and second membrane electrode assemblies.

14. The air-breathing fuel cell stack of claim 13, further comprising cathode current collectors each disposed between one the filters and the cathode of one of the membrane electrode assemblies.

15. The air-breathing fuel cell stack of claim 13, further comprising anode current collectors, having channels to distribute the fuel from the middle plate to the anodes of the first and second membrane electrode assemblies, each anode current collector disposed between one of the membrane electrode assemblies and the middle plate.

16. The air-breathing fuel cell stack of claim 13, further comprising cathode end plates to support the filters.

17. The air-breathing fuel cell stack of claim 13, wherein the air flow rate of the filters is at least about 10 Ml/min·cm².

18. The air-breathing fuel cell stack of claim 13, wherein the moisture flow rate of the filter ranges from about 100 Ml/min·cm² to about 150 Ml/min·cm².

19. The air-breathing fuel cell stack of claim 13, wherein the air flow rate of the filters is at least about 10 Ml/min·cm², and the moisture flow rate of the filters is at most about 150 Ml/min·cm².

20. The air-breathing fuel cell stack of claim 13, wherein the filters comprise pores that range in size from about 5 μm to about 20 μm.

21. The air-breathing fuel cell stack of claim 13, wherein the filter is a micro filter comprising a hydrophobic polymer.

22. The air-breathing fuel cell stack of claim 13, wherein the filter includes a basic surface to neutralize an acidic pollutant.

23. The air-breathing fuel cell stack of claim 13, wherein the filter includes an acidic surface to neutralize a basic pollutant.
